(19) United States
(12) Patent Application Publication
(10) Pub. No.: US 2020/0274874 A1
(43) Pub. Date: Aug. 27, 2020

(54) COMMUNICATION CONTROL APPARATUS, COMMUNICATION SYSTEM, AND NON-TRANSITORY COMPUTER READABLE MEDIUM

(71) Applicant: FUJI XEROX CO., LTD., TOKYO (JP)

(72) Inventor: Mitsuhisa KAMEI, Kanagawa (JP)

(73) Assignee: FUJI XEROX CO., LTD., TOKYO (JP)

(21) Appl. No.: 16/547,585

(22) Filed: Aug. 22, 2019

(30) Foreign Application Priority Data
Feb. 25, 2019 (JP) 2019-031311

(51) Int. Cl. H04L 29/06; H04L 29/08

(52) U.S. Cl. CPC H04L 63/101; H04L 63/0236; H04L 67/02

(57) ABSTRACT

A communication control apparatus includes a decision unit that refers to a list of online destinations in response to a request for access to an online destination from a source node and that determines whether the access is permitted or rejected, a receiving unit that receives from the source node an update request for updating the list of online destinations, the update request concerning the online destination to which access has been rejected by the decision unit, an evaluation unit that acquires multiple pieces of evaluation information concerning multiple items for evaluating the online destination, for which the update request has been received, and that calculates an evaluation value for each of the multiple items in accordance with the multiple pieces of evaluation information, and a generation unit that generates a piece of decision information for each of the multiple items, the piece of decision information reflecting a result of comparison between the evaluation value and one or more thresholds that correspond to the evaluation value.

### CROSS-REFERENCE TO RELATED APPLICATIONS

This application is based on and claims priority under 35 USC 119 from Japanese Patent Application No. 2019-031311 filed Feb. 25, 2019.

### BACKGROUND

### (i) Technical Field

The present disclosure relates to a communication control apparatus, a communication system, and a non-transitory computer readable medium.

### (ii) Related Art

In an access restriction system that has recently been proposed, a user is able to conveniently determine access permission/rejection in accordance with history of access to web pages from a terminal and efficiently set an access permission/rejection list suitable for the terminal (for example, refer to Japanese Unexamined Patent Application Publication No. 2010-55202).

The access restriction system described in Japanese Unexamined Patent Application Publication No. 2010-55202 includes an access list update server that updates an access permission/rejection list for a client terminal as follows. The access list update server uses a unique user (UU) number (the number of users who view a web page), information concerning forbidden words, and link information and creates a tree structure that represents a link relation between web pages viewed by using the client terminal. Then, the access list update server selects the web page having the largest UU number as a page representative of the tree structure. The access list update server creates an access history list for the client terminal, the access history list being presented either for each page, for each tree, or for each domain and transmits the access history list to a master terminal. The access list update server receives from the master terminal access permission/rejection information that determines whether the client terminal is permitted to access each web page presented on the access history list. The access list update server updates the access permission/rejection list for the client terminal in accordance with the access permission/rejection information received from the master terminal.

### SUMMARY

Aspects of non-limiting embodiments of the present disclosure relate to providing a communication control apparatus, a communication system, and a non-transitory computer readable medium that provide decision materials necessary for updating a list of online destinations that is used for determining whether the access to an online destination is permitted.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a communication control apparatus including a decision unit, a receiving unit, an evaluation unit, and a generation unit. The decision unit refers to a list of online destinations in response to a request for access to an online destination from a source node and determines whether the access is permitted or rejected. The receiving unit receives from the source node an update request for updating the list of online destinations, the update request concerning the online destination to which access has been rejected by the decision unit. The evaluation unit acquires a plurality of pieces of evaluation information concerning a plurality of items for evaluating the online destination, for which the update request has been received, and calculates an evaluation value for each of the plurality of items in accordance with the plurality of pieces of evaluation information. The generation unit generates a piece of decision information for each of the plurality of items, the piece of decision information reflecting a result of comparison between the evaluation value and one or more thresholds that correspond to the evaluation value.

### BRIEF DESCRIPTION OF THE DRAWINGS

Exemplary embodiments of the present disclosure will be described in detail based on the following figures, wherein:

FIG. 1 is an illustration depicting an example configuration of a communication system according to a first exemplary embodiment of the present disclosure;

FIG. 2 is a block diagram depicting an example control system of a gateway apparatus;

FIG. 3 is an illustration depicting template information;

FIG. 4 is an illustration depicting an example user database (DB);

FIG. 5 is an illustration depicting an example notification screen;

FIG. 6 is an illustration depicting an example decision screen;

FIG. 7 is an illustration for describing an operation for indicating the result of a decision to the decision screen depicted in FIG. 6;

FIG. 8A is an illustration depicting an example message presenting two reasons, and FIG. 8B is an illustration depicting an example message presenting one reason;

FIG. 9 is a flowchart depicting an example operation of the gateway apparatus;

FIG. 10 is an illustration depicting an example configuration of a communication system according to a second exemplary embodiment of the present disclosure;

FIG. 11 is a block diagram depicting an example control system of a gateway apparatus according to the second exemplary embodiment;

FIG. 12 is an illustration depicting an example administrator DB;

FIG. 13 is an illustration depicting an example decision screen according to a third exemplary embodiment of the present disclosure;

FIG. 14 is an illustration depicting an example administrator DB according to a first modification;

FIG. 15 is an illustration depicting an example decision screen according to a second modification; and

FIG. 16 is an illustration depicting an example decision screen according to a third modification.

### DETAILED DESCRIPTION

Exemplary embodiments according to the present disclosure will be described hereinafter with reference to the drawings. In the drawings, elements having substantially identical functions are referred to by the same reference signs, and duplicate descriptions thereof will be omitted.

### Outline of Exemplary Embodiments

Communication control apparatuses according to the present exemplary embodiments each include a decision unit, a receiving unit, an evaluation unit, and a generation unit. The decision unit refers to a list of online destinations in response to a request for access to an online destination from a source node and determines whether the access is permitted or rejected. The receiving unit receives from the source node an update request for updating the list of online destinations, the update request concerning the online destination to which access has been rejected by the decision unit. The evaluation unit acquires a plurality of pieces of evaluation information concerning a plurality of items for evaluating the online destination, for which the update request has been received, and calculates an evaluation value for each of the plurality of items in accordance with the plurality of pieces of evaluation information. The generation unit generates a piece of decision information for each of the plurality of items, the piece of decision information reflecting a result of comparison between the evaluation value and one or more thresholds that correspond to the evaluation value.

Examples of a source node include communication apparatuses such as a user terminal apparatus and an image forming apparatus connected to a network from which a communication originates. Examples of an online destination include a communication apparatus, such as a server apparatus, connected to a network that a communication reaches, and a website or a web page of the communication apparatus is also included. Examples of a list of online destinations include a white list and a black list. A white list is used to permit only a request for access to an online destination registered on the list. A black list is used to reject only a request for access to an online destination registered on the list. Pieces of information for identification, such as an IP address of a communication apparatus, a domain of a website or an email address, and a uniform resource locator (URL) of a web page, are recorded on a list of online destinations.

### First Exemplary Embodiment

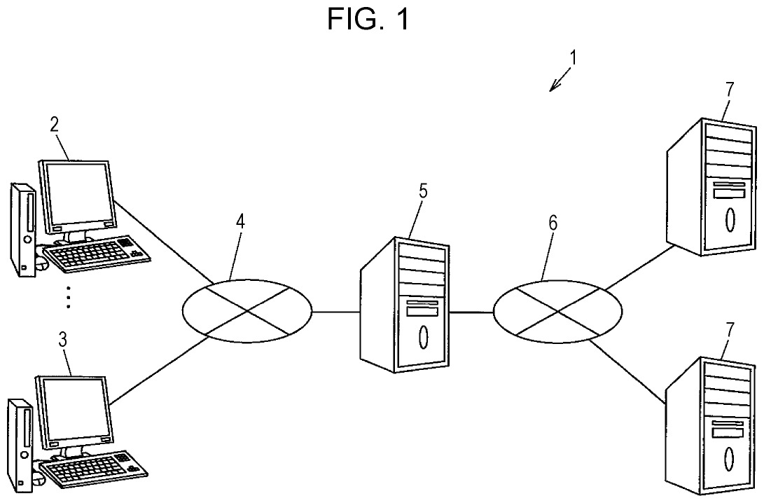

FIG. 1 is an illustration depicting an example configuration of a communication system according to a first exemplary embodiment of the present disclosure. A communication system 1 includes a plurality of user terminal apparatuses 2 operated by users, an administrator terminal apparatus 3 operated by an administrator, a gateway apparatus 5 that establishes communication between a source node and an online destination, and a plurality of server apparatuses 7. The user terminal apparatus 2 is an example of a source node. The gateway apparatus 5 is an example of a communication control apparatus. The server apparatus 7 is an example of an online destination.

The plurality of user terminal apparatuses 2 and the administrator terminal apparatus 3 are connected to the gateway apparatus 5 via an internal network 4, and the gateway apparatus 5 and the plurality of server apparatuses 7 are connected to each other via an external network 6.

An example of the user terminal apparatus 2 and the administrator terminal apparatus 3 is an information processing apparatus such as a personal computer (PC), a cell phone, or a multifunctional cell phone (smartphone), and an IP address is assigned to the information processing apparatus. The user terminal apparatus 2 may be an image forming apparatus.

The user terminal apparatus 2 and the administrator terminal apparatus 3 each include a display unit, an input unit, a controller, and a storage unit. The display unit is realized by using, for example, a liquid crystal display. The input unit is realized by using, for example, a keyboard and a mouse. The controller is realized by using, for example, a central processing unit (CPU) and an interface and performs control of, for example, input, display, and communication. The storage unit is constituted by using, for example, a read-only memory (ROM), a random-access memory (RAM), and a hard disk and stores software applications executed by the CPU and various kinds of data. The software applications include a web browser and a mailer. A web browser is application software executed to enable a user to view a web page. A mailer is application software executed to enable a user to view an email. The display unit and the input unit may be realized by using a touch panel display or the like, which integrates the display unit and the input unit as a single unit.

The internal network 4 is a network such as a local area network (LAN) or an intranet and may be a wired network or a wireless network. The external network 6 is, for example, the Internet.

The server apparatus 7 may have, for example, only a web server function, only a mail server function, or both of the functions.

The web server function is a function to provide the user terminal apparatus 2 with a web page corresponding to a URL requested by the user terminal apparatus 2 and to transmit and receive communication data to and from the user terminal apparatus 2. The mail server function is a function as a post office protocol (POP) server and a simple mail transfer protocol (SMTP) server for forwarding to a specified address an email transmitted from the user terminal apparatus 2 and an email addressed to the user terminal apparatus 2.

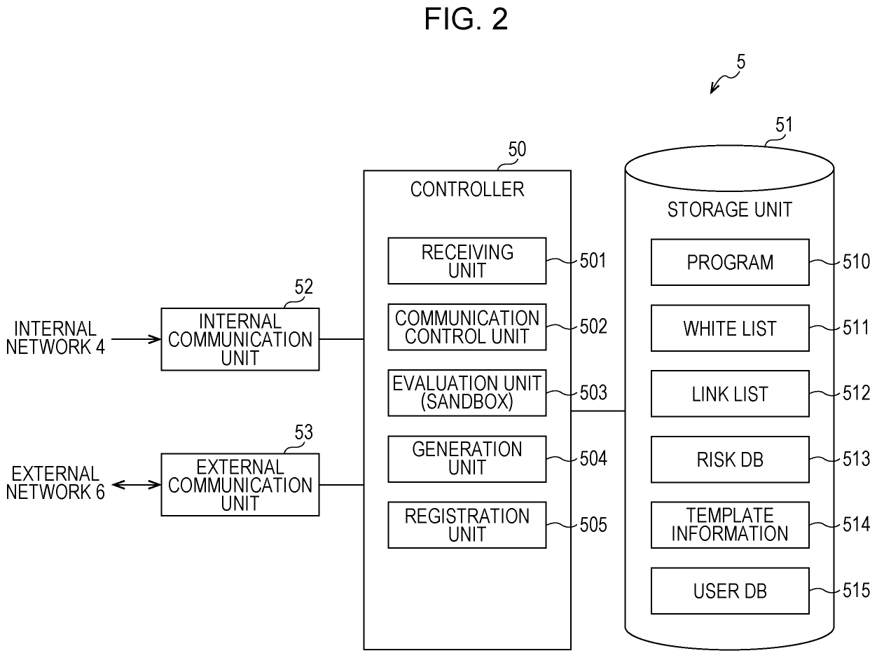

FIG. 2 is a block diagram depicting an example control system of the gateway apparatus 5. The gateway apparatus 5 includes a controller 50 that controls each unit of the gateway apparatus 5, a storage unit 51 that stores various kinds of information, an internal communication unit 52 that communicates via the internal network 4, and an external communication unit 53 that communicates via the external network 6.

The controller 50 is constituted by a CPU, an interface, and the like. The CPU operates under the control of a program 510 and thus functions as various units such as a receiving unit 501, a communication control unit 502, an evaluation unit 503, a generation unit 504, and a registration unit 505. Details of each of the units 501 to 505 will be described below. The communication control unit 502 is an example of a decision unit. The registration unit 505 is an example of an update unit.

The storage unit 51 is constituted by a ROM, a RAM, a hard disk, and the like and stores the program 510, a white list 511, a link list 512, a risk database (DB) 513, template information 514, a user DB 515, and the like. The white list 511 is an example of a list of online destinations.

For example, URLs of web pages are registered on the white list 511 as pieces of information for identifying accessible online destinations on the Internet (alternatively referred to as access destinations). The IP address, the domain of the website or the email address, and the like of the server apparatus 7 may be registered on the white list 511.

URLs of destinations linked from the web pages registered on the white list 511 are registered on the link list 512. The link list 512 is updated by the controller 50 at regular intervals (such as a week, a month, or the like).

The risk DB 513 stores conversion formulas, a calculation formula, a plurality of thresholds, pieces of color information, and the like. Each of the conversion formulas is assigned to an item to calculate an evaluation value by using pieces of evaluation information. The calculation formula is used to calculate an overall score by using evaluation values each of which is calculated for an item. The plurality of thresholds are used for comparison with an evaluation value, and a piece of color information indicates a color to represent a result of comparison between the evaluation value and the plurality of thresholds. The evaluation unit 503 uses the conversion formulas and the calculation formula. The generation unit 504 uses the plurality of thresholds and the pieces of color information. Each item may have one threshold.

The internal communication unit 52 performs control of the transmission and reception of emails and control relating to a network and transmits and receives communication data via the internal network 4.

The external communication unit 53 performs control of the transmission and reception of emails and control relating to a network and transmits and receives communication data via the external network 6.

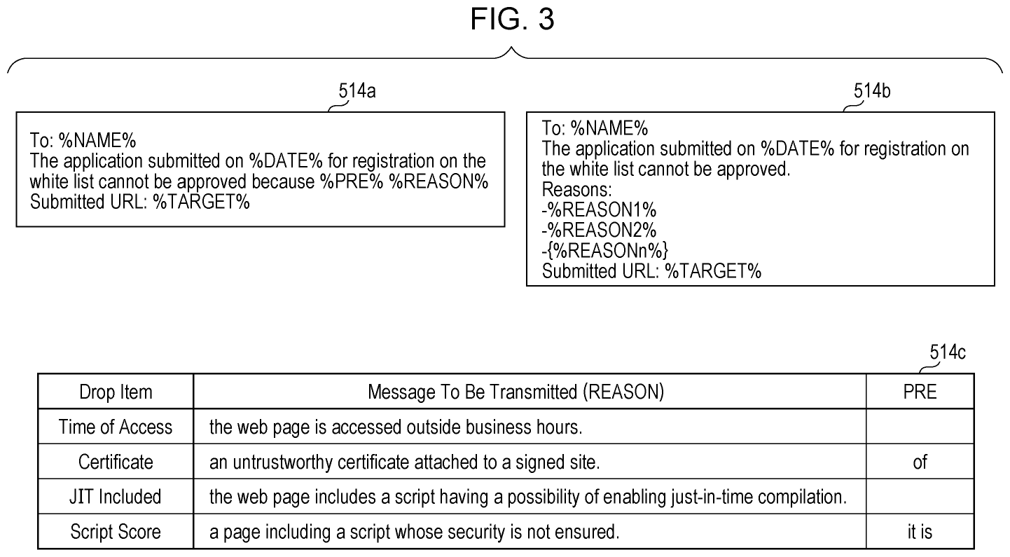

FIG. 3 is an illustration depicting an example of the template information 514. The template information 514 contains a message template 514a, a message template 514b, and a reason list 514c. The message template 514a is used when only one reason is cited to reject an application to register a URL of a web page on the white list 511 (hereinafter, also referred to simply as a “registration application”), and the message template 514b is used when two or more reasons are cited to reject a registration application. A registration application is an example of an update request.

The message template 514a for one reason is formed so as to include parameters NAME, DATE, REASON, PRE, and TARGET. The message template 514b for two or more reasons is formed so as to include parameters NAME, DATE, REASON1, REASON2, REASONn, and TARGET. The reason list 514c has a column for a drop item, a column for a reason, and a column containing the parameter PRE. The column for a drop item contains drag-and-drop items for allowing the administrator to select a reason to reject a registration application, and the column for a reason contains reasons to be entered into the parameters REASON, REASON1, REASON2, and REASONn.

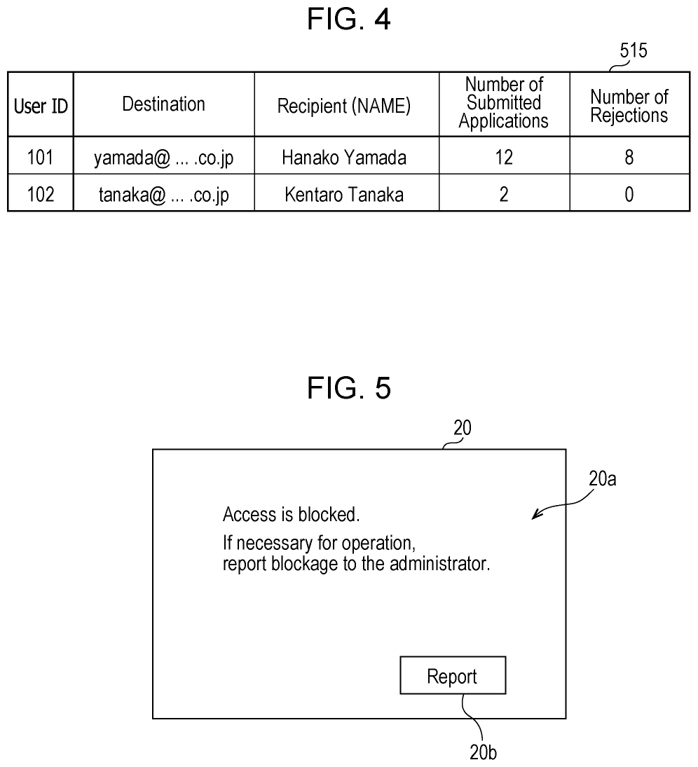

FIG. 4 is an illustration depicting an example of the user DB 515. The user DB 515 is referred to, for example, when a reply message including a reason to reject a registration application is sent to the user terminal apparatus 2. The user DB 515 includes items denoted by “User ID”, “Destination”, “Recipient”, “Number of Submitted Applications”, and “Number of Rejections”. The item denoted by “User ID” records a user ID to identify a user. The item denoted by “Destination” records an email address of a user. The item denoted by “Recipient” records the name of a user. The item denoted by “Number of Submitted Applications” records the total number of registration applications submitted by a user for registration on the white list 511. The item denoted by “Number of Rejections” records the total number of rejected registration applications.

Next, each of the units 501 to 505 of the controller 50 will be described.

The receiving unit 501 receives from the user terminal apparatus 2 a registration application to register on the white list 511 an access destination to which the access has been rejected by the communication control unit 502.

The communication control unit 502 refers to the white list 511 in response to a request for access to an access destination, the request being submitted from the user terminal apparatus 2, and determines whether the access is permitted or rejected.

The evaluation unit 503 acquires a plurality of pieces of evaluation information concerning a plurality of items that are used to evaluate an access destination for which a registration application has been submitted. Then, the evaluation unit 503 calculates an evaluation value for each item in accordance with the plurality of piece of evaluation information by using the corresponding one of the conversion formulas stored in the risk DB 513 and calculates an overall score by using the calculated evaluation values and the calculation formula stored in the risk DB 513. An evaluation value is used to evaluate, for example, the credibility of an access destination. Accordingly, a higher evaluation value indicates higher credibility of an access destination.

Examples of the items used to evaluate the credibility include items denoted by “Time of Access”, “Certificate”, “JIT Included”, “Script Score”, “Link from White List”, and “Overall Score”. The items are not limited to these and may include information obtained from WHOIS information managed by domain registrars and the like. The items may also include information concerning history regarding registration applications stored in the user DB 515. The information concerning history may include, for example, either the numbers of registration applications and rejected registration applications or a ratio of the number of rejected registration applications to the number of registration applications.

The pieces of evaluation information concerning the items described above will be described. The item denoted by “Time of Access” relates to the time when a web page is accessed. The item denoted by “Certificate” indicates whether a certificate is attached to a web page, and the item also relates to the credibility of a certificate. Examples of a certificate include a secure sockets layer (SSL) certificate used for hypertext transfer protocol (HTTP) communication. The item denoted by “JIT Included” indicates whether a script having a possibility of enabling just-in-time (JIT) compilation (for example, JavaScript (registered trademark), Flash, and the like) is included. The item denoted by “Script Score” relates to the possibility of using a function having the risk of injection. The item denoted by “Link from White List” indicates whether an access destination is linked from the white list 511, and the item also includes the period during which the link has been registered. The item denoted by “Overall Score” relates to an overall evaluation value obtained by the comprehensive evaluation of the evaluation values for the items.

A conversion formula used to convert pieces of evaluation information to an evaluation value is determined, for example, as follows. An evaluation value ranges from 0 to 100 with 100 indicating the highest credibility and 0 indicating the lowest credibility. For the item denoted by “Time of Access”, an evaluation value of 100 is assigned if a web page is accessed during business hours, and an evaluation value of 0 is assigned if a web page is accessed outside business hours. For the item denoted by “Certificate”, a web page to which a certificate is attached gains a base value of 50, to which a value depending on the credibility of the certificate (for example, 20, 30, or the like for a relatively credible certificate) is added to obtain an evaluation value. For the item denoted by “JIT Included”, if a script having a possibility of enabling JIT compilation is not included, an evaluation value of 100 is gained, and if a script having a possibility of enabling JIT compilation is included, no evaluation value is gained. For the item denoted by “Script Score”, an evaluation value is assigned in accordance with the risk of injection (for example, 100 for no risk, 80 for a certain degree of risk, or the like). For the item denoted by “Link from White List”, a web page that is not linked from the white list 511 gains no evaluation value, and a web page that is linked from the white list 511 gains an evaluation value based on the period during which the web page has been registered (for example, 100 for a web page having been registered for a month or less, 70 for a web page having been registered for half a year or less, or the like).

A formula for calculating an overall score by using evaluation values calculated for the items may be, for example, an arithmetic average or a weighted average.

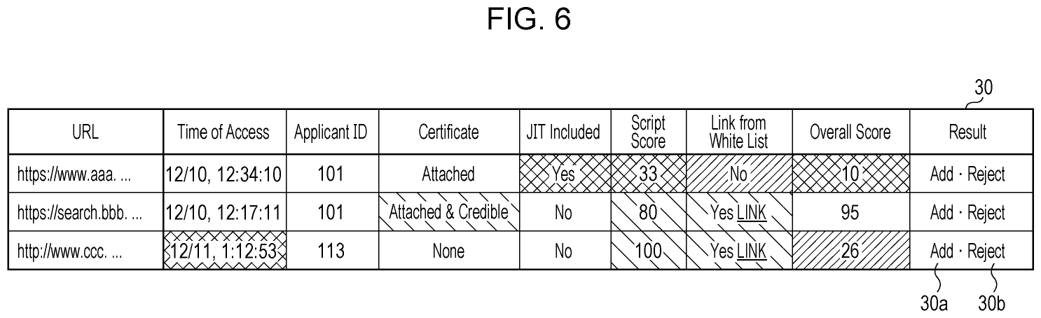

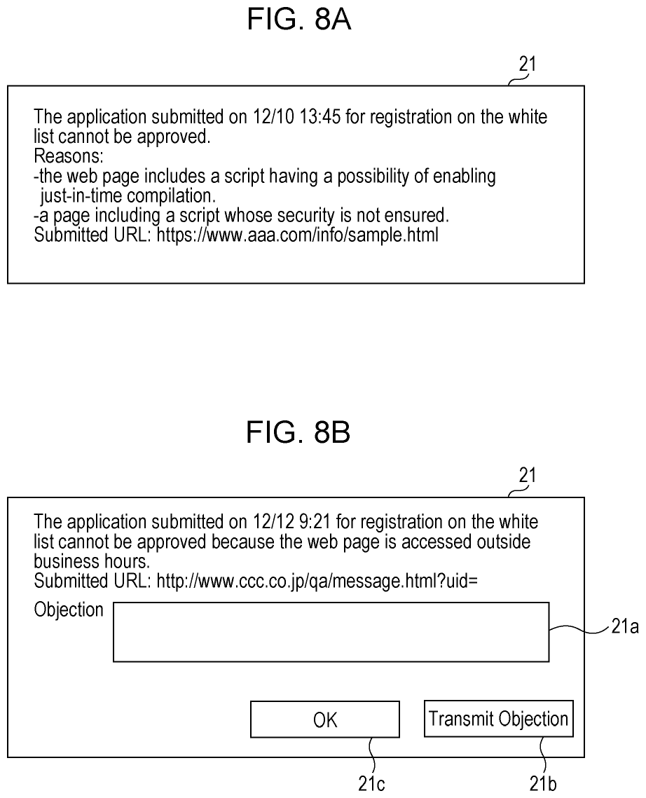

The generation unit 504 generates pieces of information that constitute a decision screen 30 (refer to FIG. 6), and the decision screen 30 reflects a result of comparison between the evaluation value and thresholds corresponding to the evaluation value for each of the items. The generation unit 504 transmits the generated pieces of information that constitute the decision screen 30 to the administrator terminal apparatus 3. Upon receiving from the administrator terminal apparatus 3 an instruction to reject a registration application, the generation unit 504 generates a reply message 21 (refer to FIGS. 8A and 8B) including at least one reason for rejection in accordance with at least one item that is identified by the administrator as a cause of rejection among the plurality of items and transmits the reply message 21 to the user terminal apparatus 2. The reply message 21 is generated by using a template in accordance with the number of items that cause rejection. The decision screen 30 is an example of decision information. The reply message 21 is an example of a sentence including a reason for rejection.

Upon receiving from the administrator terminal apparatus 3 an instruction to approve a registration application, namely an instruction to add a URL of a web page to the white list 511, the registration unit 505 registers the URL of the web page on the white list 511.

### Operation in Exemplary Embodiment

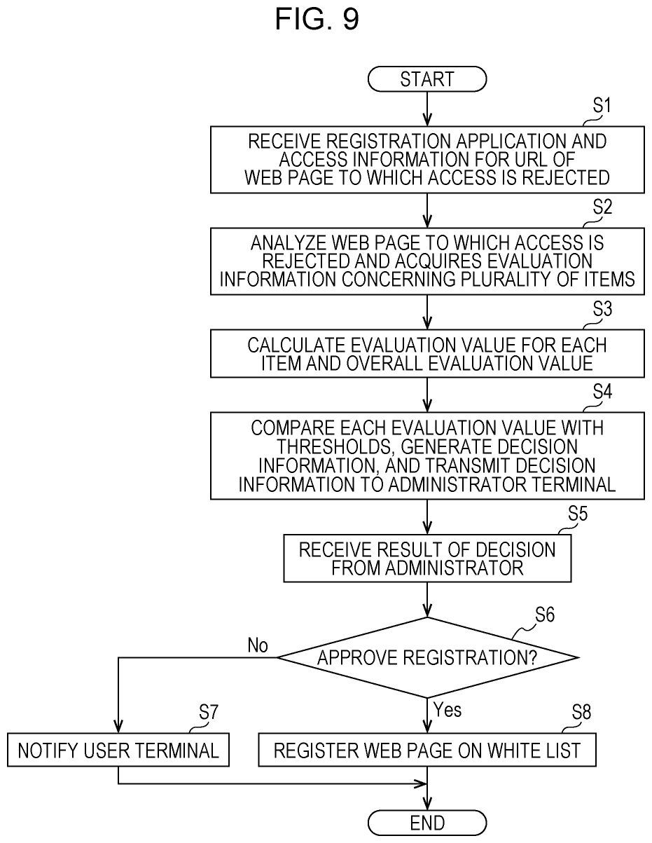

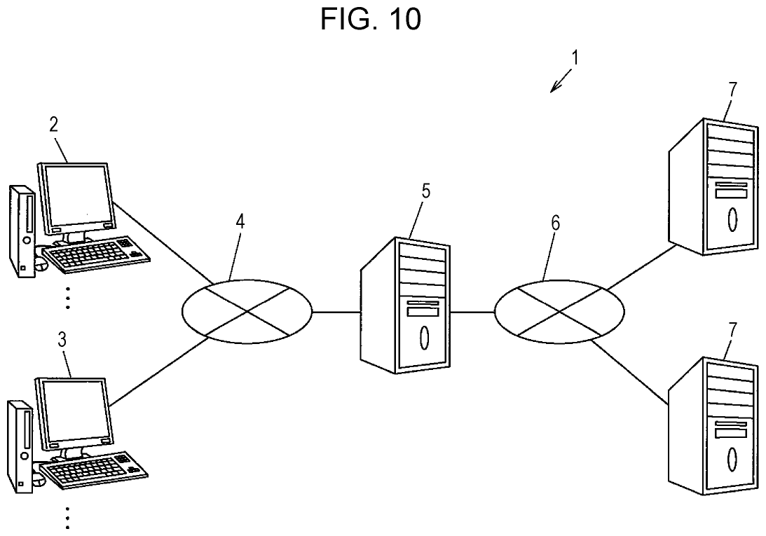

Next, an example operation of the communication system 1 will be described with reference to FIG. 5 to FIG. 9. FIG. 9 is a flowchart depicting an example operation of the gateway apparatus 5.

In response to an attempt to access a web page from the user terminal apparatus 2 via the gateway apparatus 5 and the external network 6, the communication control unit 502 of the gateway apparatus 5 permits the access if the access destination is registered on the white list 511 and rejects (also referred to as “blocks”) the access if the access destination is not registered on the white list 511.

The communication control unit 502 transmits to the user terminal apparatus 2 the information constituting a notification screen reporting the blockage of the access and causes the display unit of the user terminal apparatus 2 to display the notification screen.

FIG. 5 is an illustration depicting an example of a notification screen 20. In this example, a message 20a saying “Access is blocked. If necessary for operation, report blockage to the administrator.” and a button 20b labeled “Report” are displayed on the notification screen 20.

If a user operates the input unit of the user terminal apparatus 2 and selects the button 20b labeled “Report”, the controller of the user terminal apparatus 2 transmits to the gateway apparatus 5 a registration application for the URL of the blocked web page along with access information. The access information includes the URL of the access destination, the time of access, the user ID, and the like. The access information may be acquired by the evaluation unit 503 from the communication history information managed by the communication control unit 502 for each of the user terminal apparatuses 2 or for each of the user IDs.

The receiving unit 501 of the gateway apparatus 5 receives the registration application and the access information that are transmitted from the user terminal apparatus 2 (step S1).

After acquiring files constituting the web page for which the registration application has been submitted, the evaluation unit 503 analyzes the files and acquires pieces of evaluation information concerning each of the plurality of items (step S2).

At this time, the evaluation unit 503 uses a sandbox to monitor the files and analyzes whether an invalid operation is observed. Specifically, if a script is present, the evaluation unit 503 acquires information concerning the script, examines whether the script has a possibility of enabling JIT compilation, and assesses the risk of injection. Further, the evaluation unit 503 examines whether a certificate is attached to the web page, and if a certificate is attached, the evaluation unit 503 evaluates the credibility of the certificate. In addition, the evaluation unit 503 examines whether the URL of the web page is registered on the link list 512. The information concerning the script includes the name of the script and the like.

Next, the evaluation unit 503 calculates an evaluation value for each of the plurality of items by using the plurality of pieces of evaluation information that are acquired in step S2 described above and calculates the overall score by using the calculated evaluation values (step S3).

For example, in the case of the first row of the decision screen 30, which is depicted in FIG. 6 described below, the web page gains an evaluation value of 100 for the item denoted by “Time of Access” because the web page has been accessed during business hours, an evaluation value of 50 for the item denoted by “Certificate” because a certificate, which is attached to the web page, does not have high credibility, an evaluation value of 0 for the item denoted by “JIT Included” because the web page has a possibility of enabling JIT compilation, an evaluation value of 20 for the item denoted by “Script Score” because the risk of injection is relatively high, and an evaluation value of 0 for the item denoted by “Link from White List” because the web page is not linked from the white list 511. Then, an overall score of 10 is obtained by using these evaluation values.

Next, the generation unit 504 generates information constituting the decision screen 30, transmits the information constituting the decision screen 30 to the administrator terminal apparatus 3, and causes the display unit of the administrator terminal apparatus 3 to display the decision screen 30 (step S4).

FIG. 6 is an illustration depicting an example of the decision screen 30. The decision screen 30 includes items relating to the access information, which are denoted by “URL”, “Time of Access” (also relating to the evaluation information), and “Applicant ID”, items relating to the evaluation information, which are denoted by “Certificate”, “JIT Included”, “Script Score”, and “Link from White List”, an item for presenting the overall score, which is denoted by “Overall Score”, and an item denoted by “Result”, which is used by the administrator to select a result of a decision in response to a registration application. In the column titled “Result”, an “Add” button 30a, which is selected when the registration application is approved, and a “Reject” button 30b, which is selected when the registration application is rejected, are displayed in each row.

In the column titled “URL”, the URL of an access destination is displayed in each row. In the column titled “Time of Access”, the time of access is displayed in each row. In the column titled “Applicant ID”, the ID of the user who has submitted the registration application is displayed in each row. In the column titled “Certificate”, whether a certificate is present and whether the certificate is credible are displayed in each row. In the column titled “JIT Included”, whether a script having a possibility of enabling JIT compilation is included is displayed in each row. In the column titled “Script Score”, a script score is displayed in each row. In the column titled “Link from White List”, whether the access destination is linked from the white list 511 is displayed in each row. If the access destination is linked from the white list 511, a hyperlink to the link destination may be set. In the column titled “Overall Score”, the overall score is displayed in each row.

A cell representing an item corresponding to one of the pieces of evaluation information has a background color based on the level of an evaluation value. The generation unit 504 compares the evaluation value with a plurality of thresholds corresponding to the item and determines the background color as follows. Red (cross-hatched in FIG. 6) is assigned to a cell representing an item having the evaluation value equal to or smaller than the smallest threshold. Orange (hatched with closely spaced lines in FIG. 6) is assigned to a cell representing an item having the evaluation value equal to or smaller than the second smallest threshold. Green (hatched with widely spaced lines in FIG. 6) is assigned to a cell representing an item having the evaluation value equal to or larger than the largest threshold. Otherwise, white is assigned to a cell. The decision screen 30 enables visual recognition of the result of comparison between the evaluation value and the plurality of thresholds. The number of levels is not limited to four and may be two, three, five, or more. The background color based on the level of an evaluation value is an example of a result of comparison between an evaluation value and a plurality of thresholds.

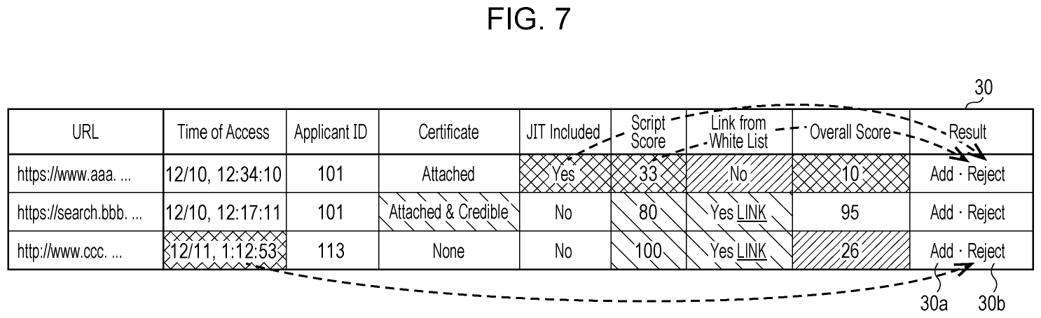

If the administrator rejects the registration application in the first row (represented by the URL https://www.aaa . . . . ) on the decision screen 30 depicted in FIG. 6, the administrator operates the input unit to perform a drag-and-drop operation and moves cells corresponding to the items titled “JIT Included” and “Script Score”, which are reasons for rejection, to the “Reject” button 30b in the column titled “Result”, as depicted in FIG. 7.

If the administrator rejects the registration application in the third row (represented by the URL http://www.ccc . . . . ) on the decision screen 30 depicted in FIG. 6, the administrator operates the input unit to perform a drag-and-drop operation and moves a cell corresponding to the item titled “Time of Access”, which is a reason for rejection, to the “Reject” button 30b in the column titled “Result”, as depicted in FIG. 7.

If the administrator approves the registration application in the second row (represented by the URL https://search.bbb . . . . ) on the decision screen 30 depicted in FIG. 6, the administrator operates the input unit and touches the “Add” button 30a in the column titled “Result” depicted in FIG. 6 and FIG. 7.

The controller of the administrator terminal apparatus 3 transmits the result of a decision to the gateway apparatus 5 (step S5). The result of a decision to reject the application includes the URL and at least one item cited as a reason for rejection. The result of a decision to approve the application includes the URL.

If the administrator rejects the registration application, namely the registration is not approved (No in step S6), the generation unit 504 reads the message template 514a or 514b, whichever matches the number of reasons, from the template information 514 and generates a reply message including at least one reason. Then, the generation unit 504 refers to the user DB 515 and notifies the user of the result by transmitting the reply message to the email address of the user (step S7).

Specifically, if the number of reasons is two or more, the generation unit 504 reads the message template 514b, which is the message template for two or more reasons, from the template information 514, substitutes reasons selected from the reason list 514c into the parameters, and generates the reply message 21 including the reasons as depicted in FIG. 8A.

If the number of reasons is one, the generation unit 504 reads the message template 514a, which is the message template for one reason, from the template information 514, substitutes a reason selected from the reason list 514c into the parameter, and generates the reply message 21 including the reason as depicted in FIG. 8B. As depicted in FIG. 8B, the reply message 21, which includes at least one reason, may have a space for objection 21a. After inputting an objection into the space for objection 21a, the user touches a button 21b labeled “Transmit Objection”. If the user agrees to the reply message 21, the user touches a button 21c labeled “OK”. The reply message 21 depicted in FIG. 8A may also allow the user to raise an objection as in FIG. 8B.

If the administrator approves the registration application, namely the registration is approved (Yes in step S6), the registration unit 505 registers the URL of the web page on the white list 511 (step S8).

### Second Exemplary Embodiment

FIG. 10 is an illustration depicting an example configuration of a communication system according to a second exemplary embodiment of the present disclosure. The case in which one administrator terminal apparatus 3 is present has been described in the first exemplary embodiment. In the second exemplary embodiment, in which a plurality of administrator terminal apparatuses 3 are present, an administrator is selected in consideration of evaluation values and proficiency levels of administrators, and a decision screen is displayed by the administrator terminal apparatus 3 of the administrator. In the following description, differences between the first exemplary embodiment and the second exemplary embodiment will mainly be described.

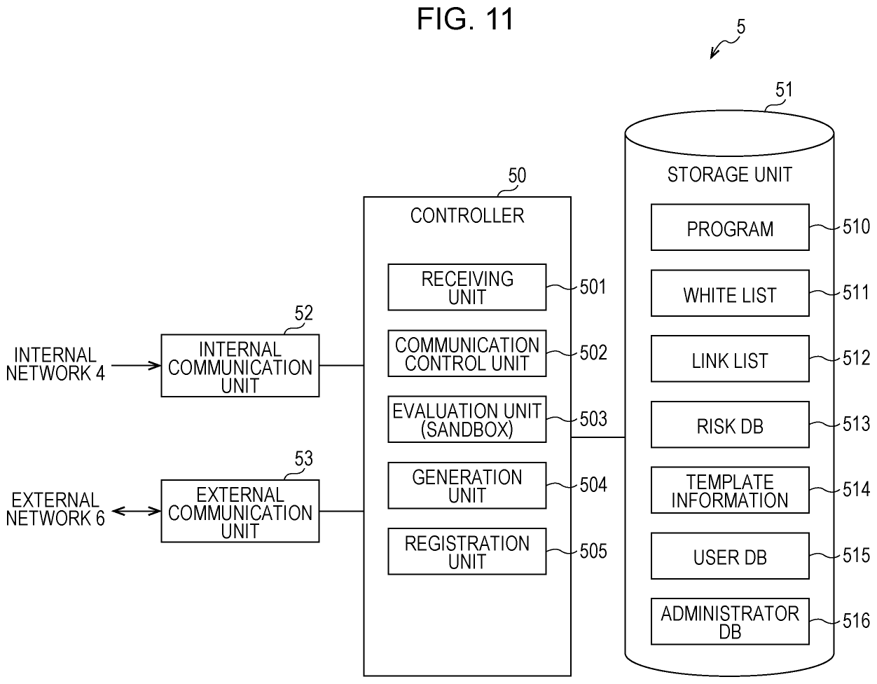

FIG. 11 is a block diagram depicting an example control system of a gateway apparatus 5 according to the present exemplary embodiment. Similarly to the gateway apparatus 5 in the first exemplary embodiment, the gateway apparatus 5 according to the present exemplary embodiment includes a controller 50, a storage unit 51, an internal communication unit 52, and an external communication unit 53. The storage unit 51 further stores an administrator DB 516.

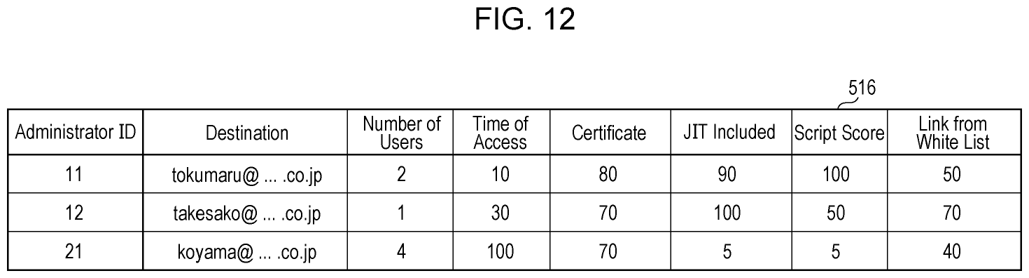

FIG. 12 is an illustration depicting an example of the administrator DB 516. The administrator DB 516 has an item denoted by “Administrator ID”, which identifies an administrator, an item denoted by “Destination”, which indicates the email address of the administrator, an item denoted by “Number of Users”, which indicates the number of users that the administrator is able to handle for a fixed period (for example, a month), items denoted by “Time of Access”, “Certificate”, “JIT Included”, “Script Score”, “Link from White List”, and the like. The items denoted by “Time of Access”, “Certificate”, “JIT Included”, “Script Score”, “Link from White List” represent proficiency levels. The proficiency level ranges from 0 to 100 with 0 indicating the lowest proficiency level and 100 indicating the highest proficiency level.

An evaluation unit 503 calculates a distance (for example, a Euclidean distance or the like) between a set of evaluation values determined for a target web page and a set of proficiency levels. An evaluation value and a proficiency level are determined for each item. The distance represents the degree of matching. A smaller distance indicates that the administrator has the ability better suited for deciding whether the web page is to be registered on the white list 511.

The evaluation unit 503 calculates a distance D by using, for example, the following equation (1).

D=Σ(100−En−Mn)², (1)

where En is an evaluation value, Mn is a proficiency level, and n is an integer equal to or larger than 1.

For example, if evaluation values for items denoted by “Time of Access”, “Certificate”, “JIT Included”, “Script Score”, and “Link from White List” are assumed to be 100, 50, 0, 20, and 100, respectively, distances D for administrators having administrator IDs 11, 12, and 21 are 4000, 7100, and 26650, respectively.

A generation unit 504 transmits the information constituting a decision screen to the administrator terminal apparatus 3 used by the administrator having the administrator ID 11, who has the smallest distance D.

The assignment may be changed so that the workload is equalized in consideration of the differences between the number of users handled by the selected administrator and the numbers of users handled by other administrators and the distances. For example, an evaluation formula such as d1×1000>d2 may be used, where d1 is the difference between the numbers of users and d2 is the difference between the distance scores. In the example in FIG. 12, since the difference between the numbers of users handled by the administrators having the administrator ID 11 and the administrator ID 12 is equal to 1, the left-hand side of the evaluation formula is equal to 1×1000. If the difference between the distance scores is smaller than 1×1000, the administrator having the administrator ID 12 may be selected as the person in charge. In this example, since the difference between the distance scores is 3100 (=7100−4000), it is determined that the administrator having the administrator ID 11 is to continue to be in charge.

### Third Exemplary Embodiment

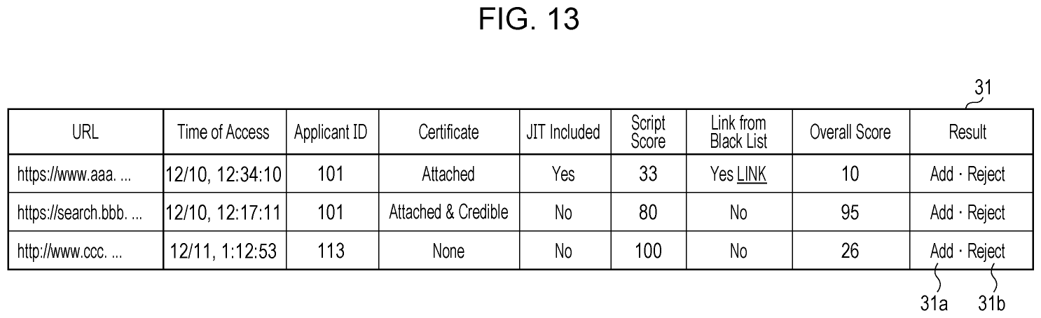

FIG. 13 is an illustration depicting an example of a decision screen 31 according to a third exemplary embodiment of the present disclosure. In the first exemplary embodiment, the case in which the white list 511 is used as an example of the list of online destinations has been described. In the present exemplary embodiment, a case in which a black list 517 is used will be described. In the following description, differences between the first exemplary embodiment and the third exemplary embodiment will mainly be described.

A storage unit 51 of a gateway apparatus 5 stores the black list 517 instead of the white list 511. URLs of web pages, for example, are registered on the black list 517. The IP address, the domain of the website or the email address, and the like of a server apparatus 7 may be registered on the black list 517.

An evaluation unit 503 acquires a plurality of pieces of evaluation information concerning a plurality of items and calculates an evaluation value for each item by using an item denoted by “Link from Black List” instead of the item denoted by “Link from White List”. If a web page is linked from the black list 517, a low evaluation value is assigned to the web page because the web page is expected to have a high risk. If a web page is not linked from the black list 517, a high evaluation value is assigned to the web page because the web page is expected to have a low risk. In FIG. 13, since the web page in the first row is linked from the black list 517, the background color of the cell in the first row in the column titled “Link from Black List” will be red. In FIG. 13, since the web pages in the second row and the third row are not linked from the black list 517, the background color of the cells in the second row and the third row in the column titled “Link from Black List” will be, for example, white. Similarly to the decision screen 30 in FIG. 6, an “Add” button 31a and a “Reject” button 31b are placed in the column titled “Result” in each row.

When a request for access to a web page is rejected, a user submits a registration application to register the web page on the white list 511 in the first exemplary embodiment. In the present exemplary embodiment, the user submits an application to remove the web page from the black list 517. An application to remove a web page is an example of an update request.

### First Modification

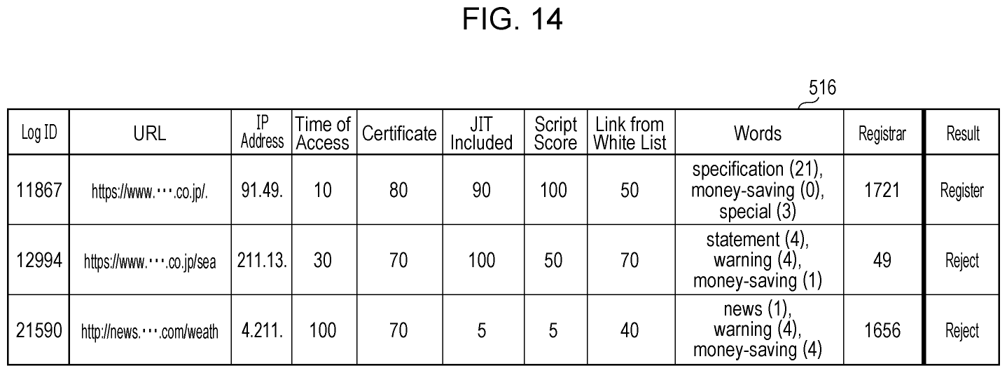

FIG. 14 is an illustration depicting an example administrator DB according to a first modification. An administrator DB 516 has an item denoted by “Log ID” and an item denoted by “URL”, which records the URL of a web page, and similarly to the administrator DB 516 depicted in FIG. 12, items denoted by “Time of Access”, “Certificate”, “JIT Included”, “Script Score”, and “Link from White List”, which relate to the proficiency level of an administrator. The administrator DB 516 further has items denoted by “IP Address”, “Words”, “Registrar”, and “Result”. A morphological analysis of the text on a web page is conducted, and words (for example, nouns and the like) and appearance frequencies of words are recorded in the column titled “Words”. In the column titled “Registrar”, the number of registrations conducted by the domain registrar that has registered the domain of the web page is recorded. In the column titled “Result”, the result of a decision made by the administrator is recorded.

A result of a past decision made for a web page similar to a web page for which a registration application is submitted is sometimes useful for a decision on the web page for which a registration application is submitted. Results of the past decisions are stored in the storage unit 51 as a log of results of decisions along with evaluation information concerning the corresponding web pages. The evaluation result based on evaluation values of the web page for which a registration application is submitted may be compared with each entry on a list of evaluation results associated with past decisions, and the similarity between the web page and each entry may be determined. Then, an entry in closer proximity than a predetermined threshold to the web page may be selected, and the result of the decision associated with the selected entry may be presented to the administrator to help in making a decision on the registration application. The distance or the degree of matching used for determining the assignment of administrators may be used to make a decision on the proximity to the web page. Techniques for evaluating the degree of similarity in appearance frequencies of words on a web page or the degree of similarity in evaluation information (for example, such as the degree of similarity measured by using the Levenshtein distance or link information) may be used.

### Second Modification

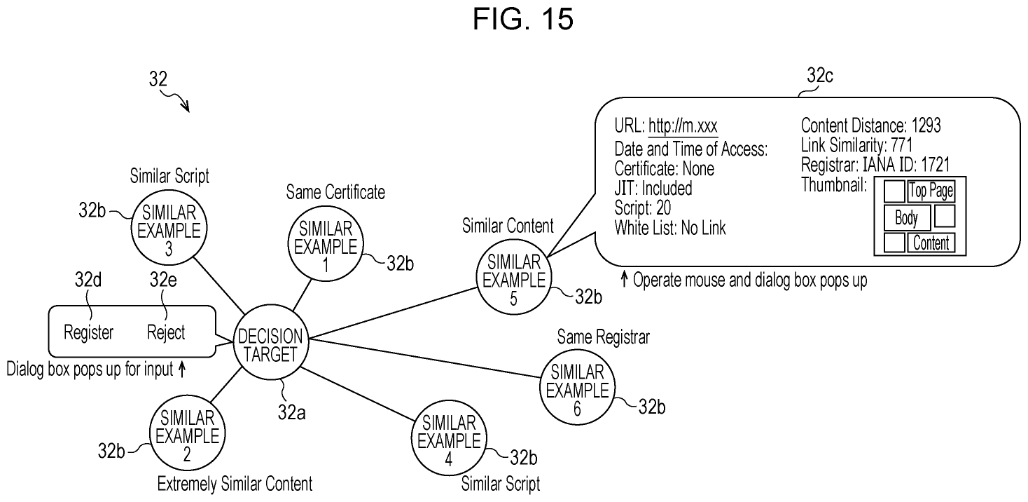

FIG. 15 is an illustration depicting an example of a decision screen according to a second modification. A decision screen 32 depicted in FIG. 15 is an example of visual information. Results of past decisions having closer similarity than a predetermined threshold to a web page for which a registration application is submitted may be presented to an administrator. Icons 32b representing results of past decisions having closer similarity are displayed in closer proximity to an icon 32a representing the decision target. The icons 32b representing results of past decisions may be colored in accordance with the degree of similarity. For ease of viewing, instead of displaying evaluation information concerning all the items, a representative item is displayed near each of the icons 32b representing results of past decisions. When the evaluation information concerning all the items is required for display, selecting one of the icons 32b representing results of past decisions causes evaluation information 32c concerning all the items to pop up near the selected one of the icons 32b. Selecting the icon 32a representing the decision target causes a “Register” button 32d and a “Reject” button 32e to be displayed near the icon 32a for receiving a result of a decision in response to the registration application.

A generation unit 504 according to the second modification generates visual information visualized by comparing the degree of similarity with thresholds and transmits the visual information to the administrator terminal apparatus 3.

### Third Modification

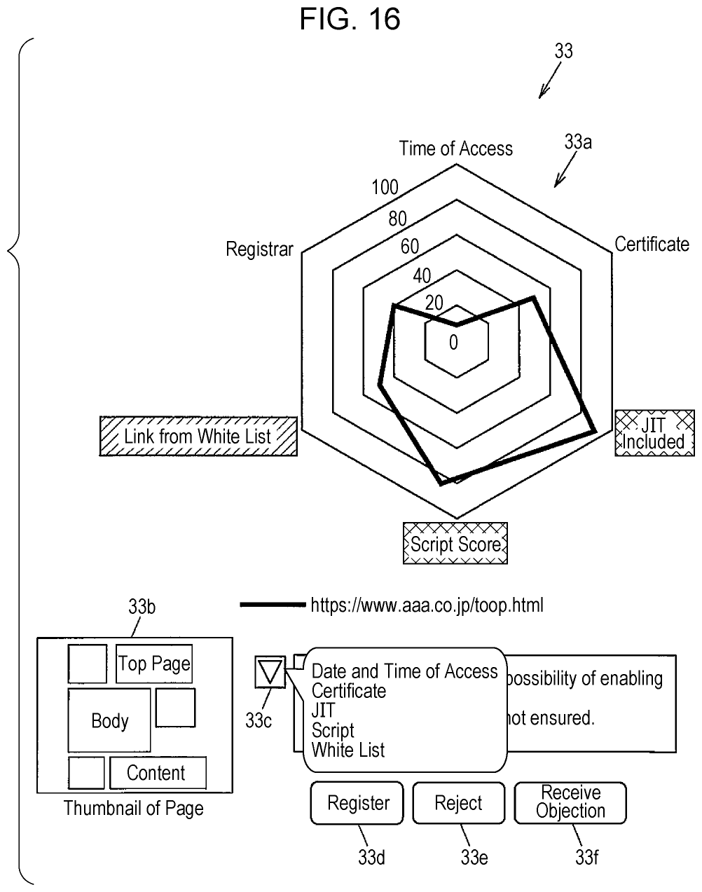

FIG. 16 is an illustration depicting an example of a decision screen according to a third modification. A decision screen 33 depicted in FIG. 16 expresses the evaluation value for each piece of decision information by using a radar chart. The decision screen 33 has a radar chart 33a, a thumbnail 33b of a web page, a cursor 33c for selecting a reason for rejection, a “Register” button 33d, a “Reject” button 33e, and a “Receive Objection” button 33f. Similarly to the decision screen 30 depicted in FIG. 6, a background color based on the evaluation value is assigned to each item in the radar chart 33a. The radar chart 33a also enables visual recognition of the result of comparison between each evaluation value and a plurality of thresholds.

The exemplary embodiments according to the present disclosure have been described as above, but the exemplary embodiments according to the present disclosure are not limited to the exemplary embodiments described above. Various modifications and practices are possible without departing from the spirit of the present disclosure.

A portion or all of each unit of the controller 50 may be constituted by a hardware circuit, such as a reconfigurable circuit (for example, a field programmable gate array (FPGA)) or an application specific integrated circuit (ASIC).

Further, some of the elements of the exemplary embodiments described above may be removed or modified without departing from the spirit of the present disclosure.

Further, addition, removal, modification, exchange, and the like of the steps in the flow in the exemplary embodiments described above are possible without departing from the spirit of the present disclosure. The programs used in the exemplary embodiments described above may be recorded on a computer-readable recording medium, such as a compact-disc ROM (CD-ROM), and provided. Alternatively, the programs used in the exemplary embodiments described above may be stored in an external server such as a cloud server and used via a network.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A communication control apparatus comprising:
a decision unit that refers to a list of online destinations in response to a request for access to an online destination from a source node and that determines whether the access is permitted or rejected;
a receiving unit that receives from the source node an update request for updating the list of online destinations, the update request concerning the online destination to which access has been rejected by the decision unit;
an evaluation unit that acquires a plurality of pieces of evaluation information concerning a plurality of items for evaluating the online destination, for which the update request has been received, and that calculates an evaluation value for each of the plurality of items in accordance with the plurality of pieces of evaluation information; and
a generation unit that generates a piece of decision information for each of the plurality of items, the piece of decision information reflecting a result of comparison between the evaluation value and one or more thresholds that correspond to the evaluation value.

2. The communication control apparatus according to claim 1,
wherein each of the pieces of decision information has a different display mode in accordance with the result of comparison.

3. The communication control apparatus according to claim 2,
wherein the different display mode has a different color.

4. The communication control apparatus according to claim 1, further comprising:
an update unit that, after the generation unit transmits the at least one piece of decision information to a terminal apparatus of an administrator, updates the list of online destinations if an instruction to approve the update request is received.

5. The communication control apparatus according to claim 2, further comprising:
an update unit that, after the generation unit transmits the at least one piece of decision information to a terminal apparatus of an administrator, updates the list of online destinations if an instruction to approve the update request is received.

6. The communication control apparatus according to claim 3, further comprising:
an update unit that, after the generation unit transmits the at least one piece of decision information to a terminal apparatus of an administrator, updates the list of online destinations if an instruction to approve the update request is received.

7. The communication control apparatus according to claim 1,
wherein, after transmitting the at least one piece of decision information to a terminal apparatus of an administrator, if an instruction to reject the update request is received, the generation unit generates a sentence including a reason for rejection in accordance with an item that is identified by the administrator as a cause of rejection among the plurality of items, and the generation unit transmits the sentence to the source node.

8. The communication control apparatus according to claim 2,
wherein, after transmitting the at least one piece of decision information to a terminal apparatus of an administrator, if an instruction to reject the update request is received, the generation unit generates a sentence including a reason for rejection in accordance with an item that is identified by the administrator as a cause of rejection among the plurality of items, and the generation unit transmits the sentence to the source node.

9. The communication control apparatus according to claim 3,
wherein, after transmitting the at least one piece of decision information to a terminal apparatus of an administrator, if an instruction to reject the update request is received, the generation unit generates a sentence including a reason for rejection in accordance with an item that is identified by the administrator as a cause of rejection among the plurality of items, and the generation unit transmits the sentence to the source node.

10. The communication control apparatus according to claim 7,
wherein the generation unit generates the sentence by using a template in accordance with the number of items that cause the rejection.

11. The communication control apparatus according to claim 8,
wherein the generation unit generates the sentence by using a template in accordance with the number of items that cause the rejection.

12. The communication control apparatus according to claim 9,
wherein the generation unit generates the sentence by using a template in accordance with the number of items that cause the rejection.

13. The communication control apparatus according to claim 1,
wherein the plurality of pieces of evaluation information include information concerning history of update requests for updating the list of online destinations submitted from the source node.

14. The communication control apparatus according to claim 13,
wherein the information concerning history includes either the numbers of the update requests and rejections of the update requests or a ratio of the number of rejections of the update requests to the number of the update requests.

15. The communication control apparatus according to claim 1,
wherein the generation unit transmits the pieces of decision information to a terminal apparatus of an administrator who has a proficiency level higher than a reference level of proficiency concerning one of the plurality of items for which the evaluation value does not satisfy a reference level of evaluation.

16. The communication control apparatus according to claim 15,
wherein the generation unit transmits the pieces of decision information to a terminal apparatus of an administrator selected by using a degree of similarity between the calculated evaluation value and a proficiency level of an administrator for each of the plurality of items.

17. The communication control apparatus according to claim 1,
wherein the generation unit transmits to a terminal apparatus of an administrator at least one piece of past evaluation information concerning an update request on which a decision has been made, the at least one piece of past evaluation information having a degree of similarity higher than a predetermined degree of similarity to the plurality of pieces of evaluation information concerning the update request received from the source node, and the generation unit also transmits to the terminal apparatus of the administrator a result of the decision that has been made.

18. The communication control apparatus according to claim 17,
wherein the generation unit generates visual information visualized by comparing the degree of similarity of the at least one piece of past evaluation information with a threshold and transmits the visual information to the terminal apparatus of the administrator.

19. A communication system comprising:
the communication control apparatus according to claim 1; and
a terminal apparatus that displays the pieces of decision information and transmits to the communication control apparatus a result of a decision of whether information for identifying the online destination is registered on the list, the decision being made in accordance with the pieces of decision information.

20. A non-transitory computer readable medium storing a program causing a computer to execute a process, the process comprising:
referring to a list of online destinations in response to a request for access to an online destination from a source node and determining whether the access is permitted or rejected;
receiving from the source node an update request for updating the list of online destinations, the update request concerning the online destination to which access has been rejected;
acquiring a plurality of pieces of evaluation information concerning a plurality of items for evaluating the online destination, for which the update request has been received, and calculating an evaluation value for each of the plurality of items in accordance with the plurality of pieces of evaluation information; and
generating a piece of decision information for each of the plurality of items, the piece of decision information reflecting a result of comparison between the evaluation value and one or more thresholds that correspond to the evaluation value.
